(19) United States
(12) Patent Application Publication
(10) Pub. No.: US 2020/0118349 A1
(43) Pub. Date: Apr. 16, 2020

(54) INFORMATION PROCESSING APPARATUS, INFORMATION PROCESSING METHOD, AND PROGRAM

(71) Applicant: SONY INTERACTIVE ENTERTAINMENT INC., TOKYO (JP)

(72) Inventor: Tatsuki AMIMOTO, TOKYO (JP)

(21) Appl. No.: 16/608,341

(22) PCT Filed: May 17, 2018
(86) PCT No.: PCT/JP2018/019185

§ 371 Date: Oct. 25, 2019

(30) Foreign Application Priority Data
May 26, 2017 (JP) 2017-104801

(51) Int. Cl. G06T 19/20; G06T 15/08; G06T 7/593; G06T 7/70

(52) U.S. Cl. CPC G06T 19/20; G06T 15/08; G06T 7/593; G06T 7/70; G06T 2219/2004; A63F 13/35; G06T 2219/2021; G06T 2200/16; G06T 2207/30196; G06T 2207/10028; G06T 2219/2016

(57) ABSTRACT

There is disclosed an information processing apparatus which acquires external appearance information associated with external appearance of a target user, generates a user object representing the target user within a virtual space on the basis of the acquired external appearance information, and changes the external appearance of the user object depending on a relationship between a browsing user browsing the user object, and the target user, in which an image exhibiting a situation of the virtual space including the changed user object is presented to the browsing user.

### TECHNICAL FIELD

The present invention relates to an information processing apparatus which draws an image in a virtual space in which an object representing a user is arranged, an information processing method, and a program.

### BACKGROUND ART

There is known a technology for building a virtual space in which user objects representing a plurality of users, respectively, are arranged. According to such a technology, the users can communicate with other users within the virtual space, or can play a game together with other users.

### SUMMARY

### Technical Problems

In the technology described above, with respect to user objects representing the respective users, the user object desirably includes the external appearance like the corresponding user, or external appearance reflecting thereon the feature of the corresponding user. As a result, the users can easily discriminate who the user object existing within the virtual space is. On the other hand, from a viewpoint of privacy protection, it is undesirable to unconditionally disclose the external appearance reflecting thereon the feature of the user to other users in some cases.

In order to cope with such a problem, it is considered that the user object itself is hidden, or the user object is covered up by the masking or the like in some cases. However, unlike a simple profile image, a photographed image or the like, the user object moves within the virtual space, or interacts circumference other objects in some cases. For this reason, it is feared that when such a user object is hidden or covered up, for the browsing user, the user object looks unnatural, or the sense of reality is impaired.

The present invention has been made in the light of the actual situation described above, and it is therefore one of objects of the present invention to provide an information processing apparatus which can suitably limit disclosure of external appearance on which a feature of a user is reflected to other users in a virtual space, an information processing method, and a program.

### Solution to Problems

An information processing apparatus according to the present invention is an information processing apparatus including: an external appearance information acquiring section acquiring external appearance information associated with external appearance of a target user; an object generating section generating a user object representing the target user in a virtual space on the basis of the external appearance information; and an object changing section changing an external appearance of the user object depending on a relationship between a browsing user who browses the user object, and the target user, in which an image representing a situation of the virtual space including the changed user object is presented to the browsing user.

An information processing method according to the present invention is an information processing method including: a step of acquiring external appearance information associated with external appearance of a target user; a step of generating a user object representing the target user, within a virtual space, on the basis of the external appearance information; and a step of changing an external appearance of the user object depending on a relationship between a browsing user who browses the user object, and the target user, in which an image representing a situation of the virtual space including the changed user object is presented to the browsing user.

A program according to the present invention is a program for causing a computer to execute: a step of acquiring external appearance information associated with external appearance of a target user; a step of generating a user object representing the target user, within a virtual space, on the basis of the external appearance information; and a step of changing external appearance of the user object depending on a relationship between a browsing user who browses the user object, and the target user, in which an image representing a situation of the virtual space including the changed user object is presented to the browsing user. This program may be provided in such a manner as to be stored in a computer-readable and non-transitory information storage medium.

### BRIEF DESCRIPTION OF DRAWINGS

FIG. 1 is a schematic view of an entire information processing system including an information processing apparatus according to an embodiment, of the present invention.

FIG. 2 is a functional block diagram depicting a function of the information processing apparatus according to the embodiment of the present invention.

FIG. 3 is a view explaining an example of a method of changing an external appearance of a user object.

FIG. 4 is a view explaining another example of the method of changing the external appearance of the user object.

FIG. 5 is a view depicting an example of a display policy.

### DESCRIPTION OF EMBODIMENTS

Hereinafter, an embodiment of the present invention will be described in detail on the basis of drawings.

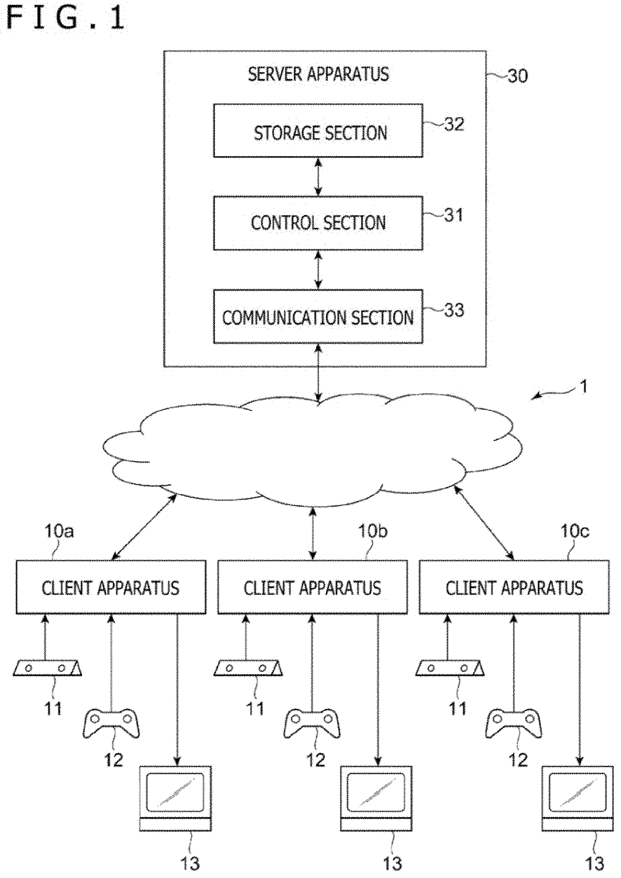

FIG. 1 is a schematic view of an entire information processing system including an information processing apparatus according to an embodiment of the present invention. The information processing system 1 is used to build a virtual space in which a plurality of users participate. According to the information processing system 1, a plurality of users can play a game together with one another, or can communicate with one another within a virtual space.

The information processing system 1, as depicted in FIG. 1, includes a plurality of client apparatuses 10, and a server apparatus 30 functioning as an information processing apparatus according to an embodiment of the present invention. In the following description, it is supposed as a specific example that three client apparatuses 10 are included in the information processing system 1. More specifically, it is supposed that the information processing system 1 includes a client apparatus 10a which a user U1 uses, a client apparatus 10b which a user U2 uses, and a client apparatus 10c which a user U3 uses.

Each of the client apparatuses 10 is an information processing apparatus such as a personal computer or a home game console, and as depicted in FIG. 1, is connected to a camera 11, an operation device 12, and a display apparatus 13.

The camera 11 photographs a situation of a real space including the user who uses the client apparatus 10. As a result, the client apparatus 10 can acquire information associated with an external appearance of the user. The client apparatus 10 transmits the information associated with the external appearance of the user obtained with the camera 11 to the server apparatus 30.

In particular, in the embodiment, it is supposed that the camera 11 is a stereo camera including a plurality of imaging elements arranged side by side. By using the images photographed with these imaging elements, the client apparatus 10 generates a distance image (depth map) including information associated with a distance from the camera 11 to a subject. Specifically, the client apparatus 10 utilizes parallaxes among a plurality of imaging elements, thereby enabling calculation of a distance from a photographing position (observation point) of the camera 11 to the subject taken within the photographed image.

The distance image is an image including information exhibiting a distance to the subject taken within each of unit regions included within a field-of-view range of the camera 11. In the embodiment, the camera 11 is installed so as to face the user of the client apparatus 10. Accordingly, the client apparatus 10 can calculate, using the photographed image through the camera 11, position coordinates within the real space with respect to a plurality of unit parts, taker, in the distance image, of the body of the user.

Here, the unit part means a part of the body of the user included in individual space regions which are obtained by dividing the real space into grids each having a predetermined size. The client apparatus 10 specifies the positions, within the real space, of the unit parts constituting the body of the user on the basis of the information associated with the distance to the subject included in the distance image. In addition, a color of the unit part is specified from a pixel value of the photographed image corresponding to the distance image. As a result, the client apparatus 10 can obtain the data indicating the position and color of the unit part constituting the body of the user. Hereinafter, the data specifying the unit part constituting the body of the user is referred to as unit part data. The client apparatus 10 calculates the unit part data on the basis of the photographed image of the camera 11, and transmits the calculated unit part data to the server apparatus 30 every predetermined time. As will be described later, unit volume elements corresponding to a plurality of unit parts, respectively, are arranged within the virtual space, thereby enabling the user to be reproduced within the virtual space with the same posture and external appearance as those in the real space.

The operation device 12 is used for the user to input various instructions to the client apparatus 10. For example, the operation device 12 includes an operation member such as an operation button, and receives an operation input of the user to the operation member. Then, the operation device 12 transmits information exhibiting the contents of the operation input to the client apparatus 10.

The display apparatus 13 displays thereon a video in response to a video signal supplied from the client apparatus 10. The display apparatus 13 may be a head-mounted display apparatus, such as a head-mounted display, which the user mounts to his/her head and uses in this state.

The server apparatus 30 is a server computer or the like, and as depicted in FIG. 1, includes a control section 31, a storage section 32, and a communication section 33.

The control section 31 includes at least one processor, and executes various kinds of pieces of information processing in accordance with a program stored in the storage section 32. The storage section 32 includes at least one memory device such as a random access memory (RAM) and stores therein a program which the control section 31 executes and data becoming a target of the processing by the program of interest. The communication section 33 is a communication interface such as a local area network (LAN) card, and is connected to each of a plurality of client apparatuses 10 via a communication network such as the Internet. The server apparatus 30 gives and receives various kinds of pieces of data to and from a plurality of client apparatuses 10 via the communication section 33.

The server apparatus 30 arranges a user object representing the user, and other objects or the like within the virtual space on the basis of the data received from the client apparatuses 10. Then, the server apparatus 30 calculates motions of a plurality of objects arranged within the virtual space, an interaction between the objects, and the like. Moreover, the server apparatus 30 draws images, in the virtual space, exhibiting situations of the objects on which the result of the calculation is reflected, and delivers the drawn images to a plurality of client apparatus 10, respectively. The image is displayed on a screen of the display apparatus 13 by the client apparatus 10, and is browsed by the user.

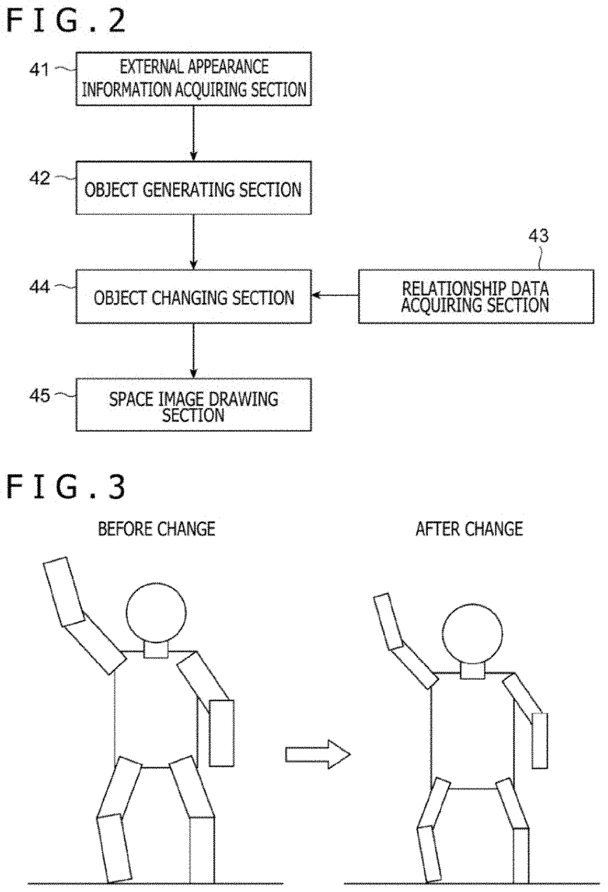

Hereinafter, a function which the server apparatus 30 realizes will be described by using a functional block diagram of FIG. 2. The server apparatus 30 functionally includes an external appearance information acquiring section 41, an object generating section 42, a relationship data acquiring section 43, an object changing section 44 and a space image drawing section 45. These functions are realized by executing a program stored in the storage section 32 by the control section 31. This program may be presented to the server apparatus 30 via a communication network such as the Internet, or may be stored in a computer-readable information storing media such as an optical disc in order to be presented.

The external appearance information acquiring section 41 acquires information associated with the external appearance of the users from the client apparatuses 10. In the following description, the information associated with the external appearance of the users which the external appearance information acquiring section 41 acquires is referred to as external appearance information of the user. In the embodiment, the pieces of unit part data of the user which are generated on the basis of the photographed image obtained from the camera 11 are acquired as the external appearance information.

The object generating section 42 generates the user objects representing the users by using the external appearance information acquired by the external appearance information acquiring section 41, and arranges the user objects within the virtual space. As a specific example, the object generating section 42 arranges, in the virtual space, the unit, volume elements corresponding to a plurality of unit parts, respectively, included in the unit part data on the basis of the unit part data acquired from the client apparatus 10a. Here, the unit volume element is one kind of object arranged within the virtual space, and the unit volume elements have the same size. A shape of the unit volume element may be a previously determined shape such as a cube. In addition, a color of each of the unit volume element is determined in accordance with a color of the unit part. In the following description, this unit volume element is indicated as a voxel.

An arrangement position within the virtual space of each of the voxels is determined in accordance with a position within the real space of the corresponding unit part, and a reference position of the user. Here, the reference position of the user is a position becoming the reference for arrangement of the user, and may be a previously determined position within the virtual space. By the voxels arranged in such a manner, the posture and external appearance of the user U1 who exists in the real space are reproduced in the virtual space. In the following description, the object representing the user U1 within the virtual space is indicated as a user object O1. In the stage in which the object generating section 42 at first generates the user object O1, the user object O1 is constituted by a set of the voxels which are arranged in accordance with the unit part data acquired from the client apparatus 10a.

Similarly to the processing with respect to the user U1, the object generating section 42 arranges, within the virtual space, the user object O2 representing the user U2 on the basis of the unit part data acquired from the client apparatus 10b. In addition, the object generating section 42 arranges, within the virtual space, the user object O3 representing the user U3 on the basis of the unit part data acquired from the client apparatus 10c. As a result, the user objects on which the external appearance of three users is reflected are arranged within the virtual space.

The object generating section 42 may arrange, within the virtual space, various kinds of objects such as the object becoming the target of the operation by the user in addition to the user object. Moreover, the object generating section 42 shall calculate the behaviors of the objects due to the interaction or the like between the objects.

The relationship data acquiring section 43 acquires data (relationship data) associated with a relationship between the users. In addition, the relationship data acquiring section 43 may also acquire display policy data of the users. These pieces of data may be read out from a database previously stored in a storage or the like which the server apparatus 30 includes. The relationship data, the display policy data and the like which are inputted in advance are stored in the data base in this case.

The relationship data is data exhibiting a relationship between two users to whom attention is paid and, for example, may be a list of users whom the users register as their friends, users who are registered in a blacklist, or the like. In addition, the relationship data acquiring section 43 may acquire attribute information (sex, age, a nationality, a residence, a hobby, and the like) of each of the users as the relationship data. In this example, the attribute information of each of the users may be data which is previously registered by the user himself/herself. In addition, in the case where the information processing system 1 realises the game function, information associated with the play situation of a game may be included in the attribute information. In addition, information (information exhibiting a user on the blacklist or the like) which is registered by a manager of the server apparatus 30 may also be included in the attribute information. Such attribute information does not directly exhibit the relationship between the users. However, an attribute relationship between the users is evaluated, or is utilized in combination with the display policy data which will be described later, thereby enabling the relationship between the users to be evaluated from the attribute information. For example, the relationship data acquiring section 43 evaluates whether the attributes of the two users to whom attention is paid, for example, agree with each other, are different from each other, or are close to each other, or the like. As a result, there is obtained the relationship data exhibiting such a relationship that the sexes of the two users as the evaluation target agree with each other or different from each other, the ages thereof are close to each other, the nationalities thereof are identical to each other, the residences thereof are close to each other, and so forth.

The display policy data is data specifying to what extent each of the users permits the disclosure of his/her external appearance to other users, and to what extent the external appearance of other users enables to be browsed. The contents of the display policy data may be ones which are previously inputted by the users, or may be ones which are previously set depending on the attribute of the users or the like. A specific example of the contents of the display policy data will be described later.

The object changing section 44 changes the external appearance of the user object arranged in the virtual space by the object generating section 42. Here, the object changing section 44 decides whether or not the external appearance of the user object is changed, or how the external appearance of the user object is changed depending on the relationship between the user corresponding to the user object (hereinafter, referred to as a target user), and the user who browses that user object (hereinafter, referred to as a browsing user). For this reason, in the case where a plurality of users browse the same user object, the external appearance of the user object is changed to the different external appearance every browsing user in some cases.

As a specific example, it is supposed that in the case where the space image drawing section 45 which will be described later draws a first space image for the user U1, and a second space image for the user U2, the user object O3 representing the user U3 is included in each of the first space image for the user U1, and the second space image for the user U2. In this case, the object changing section 44 decides the external appearance of the user object O3 included in the first space image depending on the relationship between the user U1 and the user U3, and decides the external appearance of the user object O3 included in the second space image depending on the relationship between the user U2 and the user U3. As a result, the case where the external appearance of the user object O3 differs between the first space image and the second space image occurs in some cases.

Here, the user object O3 which the object generating section 42 is to arrange is generated on the basis of the unit part data from the client apparatus 10c, and reflects the external appearance of the user U3 which is photographed with the camera 11 on the user object O3. For this reason, with respect to the space image which the user having the close relationship with the user U3 brows, the object changing section 44 basically does not change the external appearance of the original user object O3, and uses the external appearance of the original user object O3 as it is. On the other hand, with respect to the space image which the user having a shallow relationship with the user U3 brows, the control is performed in such a way that the external appearance of the user object O3 included in that space image is changed by various kinds of methods, and the external appearance of the original user U3 becomes hard to discriminate. As a result, the range in which the external appearance of the user U3 is disclosed to other users can be suitably limited. It should be noted that how the object changing section 44 changes the external appearance of the user object depending on the relationship between the users will be described in detail later.

The space image drawing section 45 draws a space image exhibiting the situation within the virtual space. This space image is one for being browsed by the users, and is delivered to the individual client apparatuses 10 connected to the server apparatus 30. Specifically, the space image drawing section 45 draws the first space image exhibiting the situation when viewing the inside of the virtual space from the position of the user object O1 corresponding to the user U1, and delivers the first space image to the client apparatus 10a which the user U1 uses. The first space image is displayed on the display apparatus 13 to be browsed by the user U1.

In the case where the user object O2 corresponding to the user U2 is included in the first space image, the space image drawing section 45 draws the first space image by using the user object O2 which is changed by the object changing section 44 depending on the relationship between the user U1 and the user U2. In addition, in the case where the user object O3 corresponding to the user U3 is included in the first space image, the space image drawing section 45 draws the first space image by using the user object O3 which is changed by the object changing section 44 depending on the relationship between the user U1 and the user U3. In addition, similarly, the space image drawing section 45 draws a second space image for the user U2, and a third space image for the user U3 by using the user object after the change by the object changing section 44, and delivers the second space image and the third space image to the client apparatus 10b and the client apparatus 10c, respectively. As a result, the user object taken within the space image which the browsing users browse shall have the external appearance after the external appearance of the user object is changed by the object changing section 44 depending on the relationship between the target user and the browsing user.

Hereinafter, a description will be given with respect to some specific examples of a changing method of changing the external appearance of the user object by the object changing section 44.

As a first example, the object changing section 44 may perform thinning of the voxels constituting the user object, thereby reducing the number of voxels. Specifically, the object changing section 44 erases a part or the voxels, arranged every predetermined interval, of the voxels constituting the user object, thereby thinning out the voxels. When such thinning is performed, the shape of the user object becomes rough, and details thereof become hard to discriminate.

As a second example, the object changing section 44 may deform the overall shape of the user object. In this example, the object changing section 44 firstly estimates a bone model of the user from the voxels constituting the user object. Here, the bone model means a model exhibiting a figure or a posture of the user. The bone model includes data exhibiting the sizes and the positions of a plurality of bones, and each of the bones corresponds to any portion of a human body such as an arm, a leg, a torso, and the like. The estimation of such a bone model can be realized by utilizing a technology such as machine learning. As a specific example, the object changing section 44 first estimates which of the portions of the human body the voxels corresponds to on the basis of a positional relationship with the circumferential voxels, and the like. Then, the object changing section 44 specifies the position and size of the bone on the basis of a distribution of the voxels corresponding to the same portion, and the like.

After the bone model is estimated, the object changing section 44 deforms the bone model in accordance with a previously determined rule. This rule, for example, may be a rule in accordance with which a length of each of the bones, and a thickness of a body surrounding the bone of interest are changed at a predetermined rate. The object changing section 44 changes the length of the bone while the connection of the bones is held by referring to such a rule. At this time, the deformation of the bone is performed with a portion close to the center of the body as a reference. In addition, in the case where the deformation in a height direction is performed, it is feared that in that way, the user object floats in the air or sinks into the ground. Then, the overall position coordinates are offset in such a way that the foot of the user object after the deformation agrees in level with the ground of the virtual space.

Thereafter, the object changing section 44 performs the rearrangement of the voxels so as to follow the bone model after the deformation. Specifically, each of the voxels is transformed to such a position as to hold a relative position for the corresponding bone. For example, in the case where attention is paid to one voxel corresponding to an upper right arm of the user, the foot of a perpendicular line caused to extend from the position of the voxel zo a central line of the bone corresponding to the upper right arm is assigned a point P. The object changing section 44 decides the rearrangement position of the voxel so that a rate of a length from the point P to the born both ends, and an angle of the voxel with respect to an extension direction of the bone do not change before and after the deformation of the born. In addition, in the case where the deformation of the thickness is performed for the bone, a distance from the voxel to the bone is also changed in accordance with the rate of the deformation. Incidentally, in the case where along with such rearrangement of the voxels, a gap is generated between the voxels, for the purpose of burying such a gap, interpolation processing using the neighborhood voxel may be executed.

FIG. 3 schematically depicts an example in which the figure of the user object is changed by executing such changing processing. In this example, the limb of the user object is changed so as to become thinner and shorter than that before the change.

By executing the changing processing as described above, the figure, the height and the like of the user object can be changed from original ones of the user. It should be noted that although in this example, the bone model is estimated from the arrangement of the voxels, the present invention is by no means limited thereto, and the object changing section 44 may deform the user object by using the bone model data specially acquired. In this case, for example, the client apparatus 10 estimates the bone model of the user by using the photographed image obtained with the camera 11, or the detection result obtained with other sensors, and transmits the estimation result together with the unit part data to the server apparatus 30.

In addition, the object changing section 44 may not only change the figure, but also change the posture of the user object. In this case, for example, the server apparatus 30 previously prepares the rule, in accordance with which the posture of the bone model is changed, for the bone model. The object changing section 44 changes the bone model in accordance with this rule, thereby changing the posture of the user. The rearrangement of the voxels responding to the changed bone model can be realized by executing the processing similarly to the processing in the case where the figure described above is changed.

As a third example, the object changing section 44 may deform a part of the user object. As an example, the object changing section 44 moves or deforms a part of parts included in the face of the user object. In this example, the object changing section 44 firstly analyzes which of the voxels constitute parts of the inside of the face (an eye, a nose, a month, a mole or the like) for the face portion of the user object. Such an analysis can be realized by using a technology such as the machine learning or the pattern matching similarly to the case of the second example.

After the parts are specified, the object changing section 44 enlarges or moves the specified parts on the basis of a predetermined rule. In the case where the parts are moved, it is only necessary that a center of gravity of the face, an intermediate point between both the eyes or the like is set as a reference point, and a distance or a direction from the reference point is changed on the basis of a predetermined rule. In addition, the rearrangement of the voxels following the enlargement or the movement of the parts can be realized similarly to the second example described above. In this case as well, in the case where the gap is generated along with the rearrangement of the voxels, the interpolation processing may be executed by using the neighborhood voxels. In addition, the parts, such as the mole, which are not essential to the face of the human may be changed in position thereof, or may be simply erased.

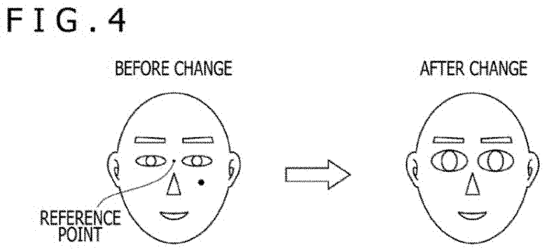

FIG. 4 schematically depicts an example in which the parts of the face of the user are changed by executing such changing processing. In this example, the eyes of the user are largely changed, and the mole located below the eye is erased.

It should be noted that the object changing section 44 may deform or erase not only the parts of the face, but also other parts. For example, the object changing section 44 may change a color for the voxel which is decided to represent a skin of the user, thereby changing the color of the skin of the user object. In addition, the object changing section 44 may change a color for the voxel which is decided to represent a cloth which the user wears. In addition, for the voxel which is decided to represent a mole, a blood vessel, a wrinkle, a fingerprint, or the like of the user in addition to the face, the object changing section 44 may perform the interpolation by using the circumferential other voxels, thereby erasing those parts.

In the above description, it is supposed that the user object after the change is also basically constituted by the voxels, and the object changing section 44 changes the external appearance of the user object by performing the erasing or rearrangement of the voxels. However, the present invention is by no means limited thereto, and the object changing section 44 may change the external appearance of the user object by, for example, replacing the voxel group with other object. A specific example of such changing processing will be described below as a fourth example.

In the fourth example, the object changing section 44 replaces a part of or all of the voxels constituting the user object with a previously prepared three-dimensional model. In this example, data associated with the three-dimensional model for replacement is previously stored within the server apparatus 30. The object changing section 44 erases all the voxels constituting the user object, and instead thereof, arranges the previously prepared three-dimensional model in the same position. It should be noted that a plurality of kinds of candidate models shall be previously prepared as the three-dimensional model for replacement, and the object changing section 44 may arrange the three-dimensional model selected from the plurality of kinds of candidate models as the user object. The three-dimensional model in this case may be a model having the external appearance which is entirely different from that of the user, or may be a model which is previously generated by reflecting a part of the external appearance of the user, thereby being registered. Incidentally, in the case where the previously prepared candidate models are used irrespective of the user, the object changing section 44 may specify the size and posture, the bone model and the like of the original user object, thereby deciding the size and posture of three-dimensional model after replacement in accordance with the specifying result. As a result, when the original user object is replaced with a different three-dimensional model, the large sense of discomfort can be prevented from being caused in the browsing user. It should be noted that the object changing section 44 may replace only a part of the voxels, constituting the user object, such as the cloth which the user wears with the three-dimensional model.

The external appearance of the user object is changed by using any of the various kinds of methods as has been described so far, resulting in that the object changing section 44 can change the external appearance of the user object every browsing user. It should be noted that the object changing section 44 may apply some of specific examples of the changing methods as has been described so far in combination. In addition, the external appearance of the user object may be changed by using a method other than the methods as has been described so far.

Next, a description will be given with respect to a specific example of processing in which the object changing section 44 selects which of the plurality of changing methods as has been described so far is used depending on the relationship between the target user and the browsing user. In the following description, for the sake of convenience of the description, the user object which is displayed as it is without performing the change by the object changing section 44 is referred to as a no change object. In addition, the user object for which the change of thinning out the voxels by using the first example is performed is referred to as a thinned object. In addition, the user object for which the processing of the voxels is performed by using the second example, and/or the third example is referred to as a processed object. Moreover, the user object which is applied in combination of the first example and the second example or the third example is referred to as a thinned⋅processed object. Then, the user object which is replaced with the three-dimensional model by using the fourth example is referred to as a model replacement object. In the following specific example, the user object which is drawn by the space image drawing section 45 shall be selected from the no change object, the thinned object, the processed object, the thinned⋅processed object, and the model replacement object depending on the relationship between the target user and the browsing user, or the like.

When as the relationship between the target user and the browsing user is higher, the object changing section 44 basically presents the user object closer to the external appearance of the target user to the browsing user as it is. In the case where the relationship between the target user and the browsing user is low, the object changing section 44 changes the external appearance of the user object to an external appearance different from that of the original user. For example, the object changing section 44 changes the external appearance of the user object between the case where the browsing user is previously registered as a friend of the target user, and the case where the browsing user is not previously registered as a friend of the target user. As a specific example, when the browsing user is previously registered as a friend of the target user, the no change object is selected (that is, the change for the user object is not carried out). On the other hand, in the case where the browsing user is not the friend of the target user, the model replacement object is selected. In addition, in the case where although the browsing user is not a friend of the target user, but the browsing user corresponds to a friend of a friend, the object changing section 44 may, for example, select the thinned object or the processed object, and the external appearance may be caused to be different from that in the case where the user does not correspond to a friend of a friend.

In addition, the object changing section 44 may select the method of changing the user object in accordance with the display policy data which the users register. In this case, what kind of changing method at least the target user requests for the browsing user every relationship is previously registered as the display policy. By way of example, it is supposed that the user U1 registers the setting in which the user U1 permits his/her friend to display the no change object and does not permit the users other than his/her friend to display the no change object, for example. The object changing section 44 selects the method of changing the user object on the basis of the relationship between the users, and the display policy data. As a result, when the browsing user is the friend of the target user, the object changing section 44 selects the no change object, and otherwise selects the method of changing the user object from the thinned object, the processed object and the like in accordance with the given order of priority.

Moreover, the object changing section 44 may select the method of changing the user object by utilizing the display policy data on the browsing user side. In this case, the browsing user, when he/she browses the user objects of other users, registers what kind of method is permitted as the method of changing the user object as a part of the display policy data. In addition, the target user and the browsing user may, with respect to the candidates of a plurality of changing methods, specify the respective orders of priority.

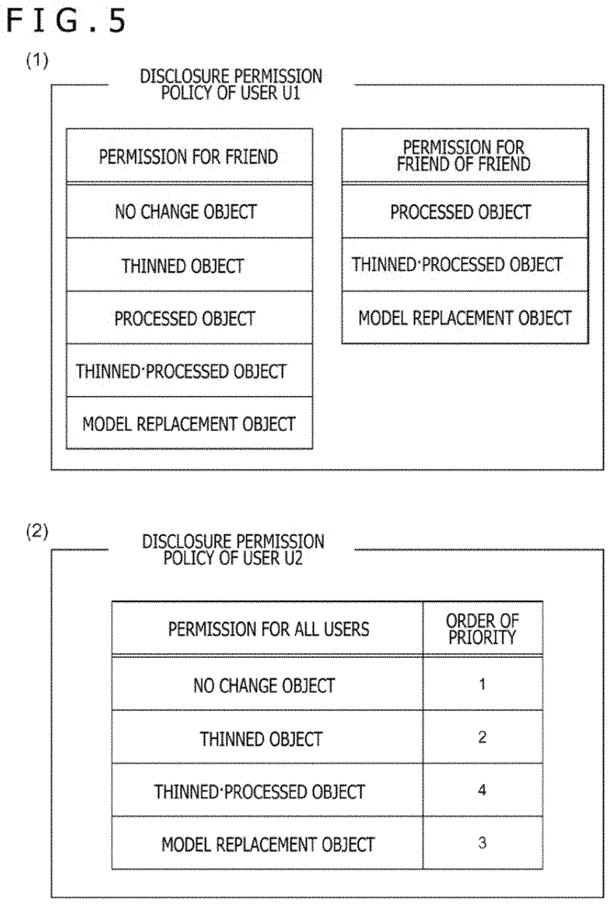

FIG. 5 depicts an example of the display policy data in this case. In this case, it is supposed that the user U1 as the display policy (disclosure permission policy) as the target user, as depicted in FIG. 5(1), permits all the changing methods with respect to a friend, and does not permit the no change object and the thinned object and permits only other changing methods with respect to a friend of the friend. On the other hand, it is supposed that the user U2, as the display policy as the browsing user (display permission policy), as depicted in FIG. 5(2), permits the no change object, the thinned object, the model replacement object, and the thinned⋅processed object, and sets the order of priority in this order. Incidentally, it is supposed that in this case, the display permission policy of the user U2 is set with all the users as the target.

In such an instance, in the case where the user U1 and the user U2 are friends, in the disclosure permission policy of the user U1, all the candidates are permitted. Therefore, the object changing section 44 selects the no change object in accordance with the order of priority of the display permission policy of the user U2. On the other hand, in the case where the user U2 correspond to the friend of the friend for the user U1, the no change object and the thinned object are not permitted from the disclosure permission policy of the user U1. For this reason, the model replacement object having the highest replacement order of priority of the permitted objects is selected as the actual changing method in accordance with the order of priority of the display permission policy of the user U2.

Incidentally, although in the above description of the changing methods which are permitted by both the disclosure permission policy and the display permission policy, the changing method having the highest order of priority shall be usually selected, the present invention is by no means limited thereto. Thus, the object changing section 44 may select an arbitrary method from the changing methods which are permitted by both the disclosure permission policy and the display permission policy depending on the processing load or the like at that time point.

For example, in the case where the user object is changed, the object changing section 44 acquires information associated with the processing load of the server apparatus 30 at that point. Then, the object changing section 44 may decide the changing method of the user object in accordance with the acquired load information. Specifically, in the case where the processing load of the server apparatus 30 is high, the object changing section 44 selects the changing method with which the number of voxels constituting the user object such as the thinned object, or the thinned⋅processed object is reduced. As a result, an amount of data to be processed can be reduced. According to such control, even when there is no change in the reliability between the browsing user and the target user or the display policy thereof, the external appearance of the user object shall be dynamically changed in accordance with the load situation.

In addition, in the case where the space image drawing section 45 draws the space image including a plurality of target users for the browsing user, the object changing section 44 may specify the target user who is to be preferentially drawn on the basis of the relationship between the browsing user and the target users, and may cause the method of changing the user object to differ between the prioritized target user and other target users. In this case, the user object corresponding to the prioritized target user is caused to have the external appearance which is closer to the original external appearance and details of which can be confirmed. In addition, each of the user objects corresponding to other target users is caused to have the relatively simplified external appearances.

As a specific example, it is supposed that the browsing user is the user U1, the user U3 is the friend of the user U1, and the user U2 is not a direct friend of the user U1, but is the friend of the friend. Moreover, it is supposed that the display policy performs the setting in which each of the user U2 and the user U3 permits the user U1 to browse the no change object. In this example, in the case where the processing load of the server apparatus 30 is light, the object changing section 44 causes each of the user objects O2 and O3 included in the space image which the user U1 browses to be the no change object. However, in the case where the processing load of the server apparatus 30 becomes high, with respect to the user U2 having the relatively low relationship with the user U1, the object is changed to the thinned object or the like having the low processing load, and with respect to the user U3 having the relatively high relationship, the object is displayed as it is without the change. In addition, even in the case where both the objects may be changed to the thinned object, for example, the thinning rate of the user object O2 corresponding to the user U2 having the low relationship may be increased, thereby obtaining the changed external appearance which is more simplified than the user object O3. According to such control, even in the case where it is necessary to change the user object to the simplified contents depending on the processing load, the user object corresponding to the target user having the high relationship with the browsing user shall be displayed in external appearance the contents of which can be preferentially confirmed.

In addition, although in the above description, each of the users can arbitrarily register the display policy data, the manager of the server apparatus 30 may register at least a part of the display policy. In addition, for example, the policy with which the user object is displayed in a high quality form can be selected by only a part of the users, and so forth, and thus the range of the selectable display policy may differ every user.

In addition, the object changing section 44 may decide the method of changing the user object by using the positional coordinates of the user objects within the virtual space. Specifically, the object changing section 44 decides the method of changing the user object depending on to what extent two user objects approach each other within the virtual space. As an example, in the case where the target user and the browsing user are friends, the no change object is displayed in the case where the target user and the browsing user approach to a predetermined distance D1 or less within the virtual space, while the thinned object is displayed in the case where the target user and the browsing user are located at more than the predetermined distance D1 located away from each other. In addition, in the case where the browsing user is the friend of the friend of the target user, the no change object is displayed in the case where the target user and the browsing user approach to a predetermined distance D2 or less, while the thinned object is displayed in the case where the target user and the browsing user are located at more than the predetermined distance D2 away from each other. At this time, a condition of D1>D2 holds. As a result, when viewed from the browsing user, the party having the high relationship can be clearly recognised even when being located apart from the browsing user to some extent, and in case of the party having the relative low relationship, the party is hard to recognize unless getting sufficiently close to the browsing user.

It should be noted that the object changing section 44 may change step by step the external appearance of the user object depending on not only whether or not the distance between the target user and the browsing user becomes simply the predetermined distance less, but also whether or not the distance between the target user and the browsing user falls within a predetermined distance range. In addition, a distance being a threshold value with which the external appearance of the user object is changed may be changed depending on the azimuth when viewed from the user object of the target user. As a result, in the case where the external appearance is browsed by other users from a dead angle for the user himself/herself, such control as to obscure the details of the external appearance and so forth can be realized.

In addition, similarly to the example in which the order of priority of the target user is decided on the basis of the relationship between the users described above, the object changing section 44 may decide the order of priority for the drawing of the use objects depending on the distance, within the virtual space, up to each of the user objects. Specifically, in the case where a plurality of user objects are drawn, when the processing load is light, all the user objects are made the no change object. On the other hand, in the case where the processing load becomes high, the user object having the high order of priority is made the no change object as it is, while the user object having the low order of priority is changed to the thinned object. In addition, in the case where both the use objects are made the thinned object, the thinning rate of the user object having the low order of priority is increased. The order of priority in this case is decided in accordance with the distance from the position where the user object of the browsing user is arranged up to the user object of the drawing target. That is to say, as the distance is shorter for the user object, the order of priority is made higher, and as the distance is longer for the user object, the order of priority is made lower. Alternatively, the object changing section 44 may decide the order of priority of drawing each of the user objects depending on both the distance up to each of the user objects, and the relationship between the users.

Moreover, the object changing section 44 may decide the method of changing the user object depending on not only the positional relationship between the target user within the virtual space and the browsing user, but also a position of another third user. In the following description, it is supposed that as a specific instance, the target user is the user U1, the browsing user is the user U2, and both the user U1 and the user U2 are not registered as the friends. However, the user U3 is regarded as the friend of both the user U1 and the user U2. In a word, it is supposed that the user U1 and the user U2 have a relationship of a friend of a friend via the user U3.

In the case where in such an instance, the user object O3 of the user U3 is absent within the virtual space, since the user U1 is other person when viewed from the user U2, in the space image which is browsed by the user U2, the user object O1 of the user U1 is changed to a form external appearance of which is hard to discriminate. However, in the case where the user object O3 of the user U3 approaches each of the user objects O1 and O2 to the predetermined distance or less within the virtual space, the external appearance of the user object O1 shall be displayed similarly to the case where the user U1 and the user U2 are friends. According to such control, similarly to the case where the communication is performed in the real world and so forth, the change of the relationship via the common friend can be represented.

Incidentally, when the common friend (in this case, the user U3) merely approaches the user to the predetermined distance or less, the object changing section 44 may not change the external appearance of the user object, but may change the external appearance of the user object in the case where the positional relationship among three users meets a predetermined condition. Moreover, a condition associated with a direction of each of the user objects may be included in the predetermined condition in this case. As a result, for example, in the case where three users have such a form as to face one another, the external appearance of the user object can be changed. In addition, in the case where the user object of the target user, and the user object of the browsing user perform a predetermined gesture such as a handshake or a hug followed by the mutual contact, the external appearance of the user object may be changed. In addition, in the case where the various kinds of conditions as has been described so far are met, the object changing section 44 does net automatically change the external appearance, but inquires the target user. Then, in the case where the target user performs operation input or the like, for the operation device 12 and responds to the inquiry, the external appearance of the user object may be changed.

According to the server apparatus 30 of the embodiment of the present invention described so far, the external appearance of the user object is changed depending on the relationship between the users, resulting in that the disclosure of the user object, on which the external appearance of the user is reflected, to other person can be limited within the desirable range.

It should be noted that the embodiment of the present invention by no means limited to the embodiment described so far. For example, in the above description, the user object before the change is supposed to be generated by using the data associated with the distance image generated with the photographed image obtained with the stereo camera. However, the present invention is by no means limited thereto, and the client apparatus 10 may acquire the data associated with the distance image by using a sensor which can measure the distance to the subject by using other system such as a time of flight (TOF) system. In addition, the external appearance information acquiring section 41 may acquire other information associated with the external appearance of the user instead of acquiring the unit part data based on the distance image. For example, the external appearance information acquiring section 41 may acquire the data associated with the previously generated three-dimensional model on which the external appearance of the user is reflected as the external appearance information. In addition, the object generating section 42 may arrange, in the virtual space, the user object on which the external appearance of the user is reflected by using the data associated with the three-dimensional model.

In addition, although in the above description, the object changing section 44 is supposed to only change the external appearance of the user object, in the case where a sound of the target user is delivered to other users, the object changing section 44 may process the sound by frequency shift processing or the like if necessary.

In addition, the client apparatus 10 may execute a part of the processing which in the above description, the server apparatus 30 is supposed to execute. As an example, the function of the space image drawing section 45 may be realized by the client apparatus 10. In this case, the server apparatus 30 delivers the data associated with the user object which is changed depending on the relationship between the users to the client apparatus 10. The client apparatus 10 draws the space image including the user object and presents the space image thus drawn to the browsing user.

Moreover, in this case, in the example in which the method of changing the user object is decided depending on the processing load of the server apparatus 30 described above, instead of the processing load of the server apparatus 30, or in addition thereto, the method of changing the user object may be decided depending on a load (a use situation of a communication band or the like) of a communication network which is used in the delivery of the data associated with the user object. Specifically, in the case where the load of the communication network is high, the object changing section 44, for example, changes the user object of the target user having the low relationship with the browsing user, or the user object which is located in a position far from the browsing user within the virtual space to the thinned object, thereby reducing an amount of data constituting the user object. As a result, in the case where the load of the communication network becomes high, an amount of data which is to be transmitted via the communication network of interest can be dynamically reduced.

In addition, the client apparatus 10 may generate the user object on which the external appearance of the target user using the client apparatus 10 of interest is reflected, and may change the external appearance of the user object depending on the browsing user. In this case, for example, the client apparatus 10 receives information associated with a plurality of users each having the possibility of browsing the user object of the current target user from the server apparatus 30, and executes the processing for changing the user objects responding to each of a plurality of browsing users. Then, the client apparatus 10 transmits the data associated with the user object after the change to the server apparatus 30. In this case, the client apparatus 10 shall function as the information processing apparatus according to the embodiment of the present invention.

### REFERENCE SIGNS LIST

1 Information processing system, 10 Client apparatus, 11 Camera, 12 Operation device, 13 Display apparatus, 30 Server apparatus, 31 Control section, 32 Storage section, 33 Communication section, 41 External appearance information acquiring section, 42 Object generating section, 43 Relationship data acquiring section, 44 Object changing section, 45 Space image drawing section.

1. An information processing apparatus comprising:
an external appearance information acquiring section acquiring external appearance information associated with external appearance of a target user;
an object generating section generating a user object representing the target user in a virtual space on a basis of the external appearance information; and
an object changing section changing an external appearance of the user object depending on a relationship between a browsing user who browses the user object, and the target user,
wherein an image representing a situation of the virtual space including the changed user object is presented to the browsing user.

2. The information processing apparatus according to claim 1, wherein, in a case where the relationship between the browsing user and the target user is low, the object changing section changes the external appearance of the user object to external appearance different from that of the target user.

3. The information processing apparatus according to claim 1, wherein the object changing section changes the external appearance of the user object between a case where the browsing user is registered as a friend of the target user and a case where the browsing user is not registered as the friend of the target user.

4. The information processing apparatus according to claim 1, wherein the object changing section changes the external appearance of the user object representing the target user depending on a positional relationship, within the virtual space, between the user object representing the target user, and the user object representing the browsing user.

5. The information processing apparatus according to claim 4, wherein the object changing section changes the external appearance of the user object representing the target user depending on a positional relationship, within the virtual space, among the user object representing the target user, the user object representing the browsing user, and a user object representing a third user pertaining to both the target user and the browsing user.

6. The information processing apparatus according to claim 1, further comprising:
a policy acquiring section acquiring a disclosure permission policy relating to disclosure permission to other users of the user object representing the target user,
wherein the object changing section changes the external appearance of the user object by using a method selected from a plurality of changing methods in accordance with contents of the disclosure permission policy.

7. The information processing apparatus according to claim 6, wherein the policy acquiring section further acquires a display permission policy prescribing a changing method, with which the browsing user permits display, of the plurality of changing methods, and
the object changing section changes the external appearance of the user object by the method selected from the plurality of changing methods on a basis of both the disclosure permission policy and the display permission policy.

8. The information processing apparatus according to claim 1, wherein the object changing section changes the external appearance of the user object depending on at least one of a processing load of the information processing apparatus, and a load of a communication network in which data associated with the user object after the change is transmitted.

9. The information processing apparatus according to claim 1, wherein the external appearance information acquiring section acquires information associated with a distance image obtained by photographing the target user as the external appearance information, and
the object generating section arranges a plurality of unit volume elements within the virtual space on a basis of the information associated with the distance image, thereby generating the user object.

10. The information processing apparatus according to claim 9, wherein the object changing section erases a part of the unit volume elements arranged every predetermined interval within the virtual space, thereby changing the external appearance of the user object.

11. The information processing apparatus according to claim 9, wherein the object changing section rearranges the plurality of unit volume elements in accordance with a predetermined rule, thereby changing the external appearance of the user object.

12. The information processing apparatus according to claim 9, wherein the object changing section replaces the plurality of unit volume elements with a previously prepared three-dimensional model, thereby changing the external appearance of the user object.

13. An information processing method comprising:
acquiring external appearance information associated with external appearance of a target user;
generating a user object representing the target user, within a virtual space, on a basis of the external appearance information; and
changing an external appearance of the user object depending on a relationship between a browsing user who browses the user object, and the target user, wherein an image representing a situation of the virtual space including the changed user object is presented to the browsing user.

14. A program for a computer, comprising:
by an external appearance information acquiring section, acquiring external appearance information associated with external appearance of a target user; by an object generating section, generating a user object representing the target user, within a virtual space, on a basis of the external appearance information; and
by an object changing section, changing an external appearance of the user object depending on a relationship between a browsing user who browses the user object, and the target user,
wherein an image representing a situation of the virtual space including the changed user object is presented to the browsing user.
